(19) United States
(12) Patent Application Publication
(10) Pub. No.: US 2026/0026658 A1
(43) Pub. Date: Jan. 29, 2026

(54) SCOOP

(71) Applicant: O INTERNATIONAL INC., Fossambault-sur-le-Lac (CA)

(72) Inventors: Cassandra PICHETTE, Fossambault-sur-le-Lac (CA); Yoan ROBITAILLE, Fossambault-sur-le-Lac (CA)

(21) Appl. No.: 18/998,365

(22) PCT Filed: Jul. 26, 2023
(86) PCT No.: PCT/CA2023/050999

§ 371 Date: Jan. 24, 2025

Related U.S. Application Data
(60) Provisional application No. 63/392,609, filed on Jul. 27, 2022.

(51) Int. Cl. A47J 43/28; G01F 19/00

(52) U.S. Cl. CPC A47J 43/28; G01F 19/002

(57) ABSTRACT

A scoop comprising: a sheet constructed of a foldable material, the sheet including: a pair of lateral scores extending across the sheet including a first lateral score segment and a second lateral score segment extending away from an axis and respectively toward the first lateral side and the second lateral side, the first and second lateral scores extending transversally to the axis, obliquely relative the axis and towards the rear; a handle portion extending from the rear side to the pair of lateral scores, the handle portion foldable in half around the axis; and a cup portion extending from the front side to the lateral score, the cup portion including a pair of longitudinal cup scores extending between the front side and the pair of lateral score, towards the axis; lateral sheet edges extending continuously along the first lateral side and the second lateral side, alongside both the handle portion and the cup portion.

### FIELD

This application relates generally to utensils or other like service implements and, more particularly, to utensils formed from a flat blank.

### BACKGROUND

Consumable products provided in granulated and/or powdered form are commonplace. Oftentimes, such fine particle products are sold in quantities greater than that intended for a single serving. Whereas the volume or mass of product intended per serving may be indicated on packaging, portioning and dispensing the product in a tidy and accurate manner remain challenging in most cases. Moreover, environmental concerns have increased over the last decade and many clients of fine particle products such as beverage powders are concerned about their environmental footprint and are interested in minimizing the environmental footprint of the products they consume. While existing utensils were satisfactory to a certain degree, there remained room for improvement.

### SUMMARY

In accordance with one aspect, there is provided a scoop comprising: a sheet constructed of a foldable material, the sheet extending longitudinally along an axis between a front side and a rear side and laterally between a first lateral side and a second lateral side on either side of the axis, the sheet including: a pair of lateral scores extending across the sheet including a first lateral score segment and a second lateral score segment extending away from the axis and respectively toward the first lateral side and the second lateral side, the first and second lateral scores extending transversally to the axis, obliquely relative the axis and towards the rear; a handle portion extending from the rear side to the pair of lateral scores, the handle portion foldable in half around the axis; and a cup portion extending from the front side to the lateral score, the cup portion including a pair of longitudinal cup scores extending between the front side and the pair of lateral score, towards the axis; lateral sheet edges extending continuously along the first lateral side and the second lateral side, alongside both the handle portion and the cup portion; wherein the sheet is reversibly configurable between: a flat configuration in which the cup portion and the handle portion lay flat in a common plane; and a formed configuration in which the cup portion defines a cavity and the handle portion defines a channel in register with the cavity.

In accordance with another aspect, there is provided a scoop comprising: a sheet constructed of a foldable material, the sheet extending longitudinally along an axis between a front side and a rear side and laterally between a first lateral side and a second lateral side on either side of the axis, the sheet including: a lateral score extending across the sheet including a first lateral score segment and a second lateral score segment extending away from the axis and respectively toward the first lateral side and the second lateral side; a handle portion extending from the rear side to the lateral score, the handle portion including at least one longitudinal handle score extending between the lateral score and the rear side; and a cup portion extending from the front side to the lateral score, the cup portion including a lateral cup score extending across the sheet from the first lateral side to the second lateral side; wherein the sheet is reversibly configurable between: a flat configuration in which the cup portion and the handle portion lay flat; and a formed configuration in which the cup portion defines a cavity and the handle portion defines a channel in register with the cavity, the cavity defining a funnel narrowing from the lateral cup score to the lateral score.

In accordance with another aspect, there is provided a scoop comprising: a sheet constructed of a foldable material, the sheet extending longitudinally along an axis between a front side and a rear side and laterally between a first lateral side and a second lateral side on either side of the axis, the sheet including: a lateral score extending across the sheet including a first lateral score segment and a second lateral score segment extending away from the axis and respectively toward the first lateral side and the second lateral side; a handle portion extending from the rear side to the lateral score, the handle portion including at least one longitudinal handle score spaced apart and extending between the lateral score and the rear side; and a cup portion extending from the front side to the lateral score, the cup portion including a pair of longitudinal cup scores extending between the front side and the lateral score; wherein the sheet is reversibly configurable between: a flat configuration in which the cup portion and the handle portion lay flat; and a formed configuration in which the cup portion defines a cavity and the handle portion defines a channel in register with the cavity.

In accordance with another aspect, there is provided a scoop comprising: a sheet constructed of a foldable material, the sheet extending longitudinally along an axis between a front side and a rear side and laterally between a first lateral side and a second lateral side on either side of the axis, the sheet including: a lateral score extending across the sheet including a first lateral score segment and a second lateral score segment extending away from the axis and respectively toward the first lateral side and the second lateral side; a handle portion extending from the rear side to the lateral score, the handle portion including a pair of longitudinal handle scores spaced apart and extending between the lateral score and the rear side; and a cup portion extending from the front side to the lateral score; wherein the sheet is reversibly configurable between: a flat configuration in which the cup portion and the handle portion lay flat; and a formed configuration in which the cup portion defines a cavity and the handle portion defines a channel in register with the cavity.

In accordance with another aspect, there is provided a kit of parts including a bag containing a quantity of beverage powder and a scoop, the scoop comprising: a sheet constructed of a foldable material, the sheet extending longitudinally along an axis between a front side and a rear side and laterally between a first lateral side and a second lateral side on either side of the axis, the sheet including: a lateral score extending across the sheet including a first lateral score segment and a second lateral score segment extending away from the axis and respectively toward the first lateral side and the second lateral side; a handle portion extending from the rear side to the lateral score, the handle portion including a pair of longitudinal handle scores spaced apart and extending between the lateral score and the rear side; and a cup portion extending from the front side to the lateral score.

Many further features and combinations thereof concerning the present improvements will appear to those skilled in the art following a reading of the instant disclosure.

### DESCRIPTION OF THE FIGURES

Reference is now made to the accompanying figures in which:

FIG. 1 is a perspective view of a scoop shown in a formed configuration according to one or more embodiments;

FIG. 2A is another perspective view of the scoop of FIG. 1, shown in use for collecting a granular product from a first container;

FIG. 2B is another perspective view of the scoop of FIG. 1, shown in use for transferring the granular product into a second container; and

FIG. 3 is a top plan view of the scoop of FIG. 1 shown in a flat configuration according to one or more embodiments.

### DETAILED DESCRIPTION

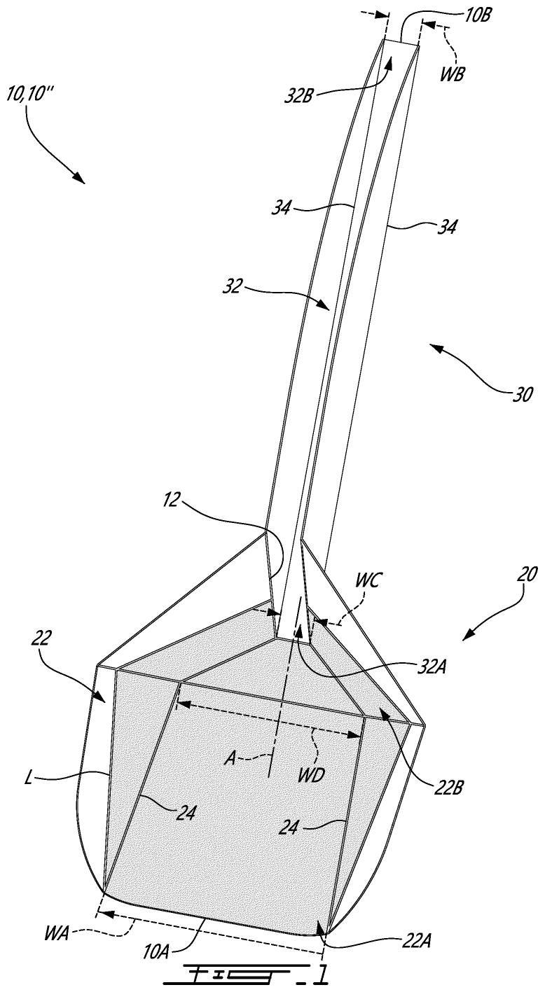

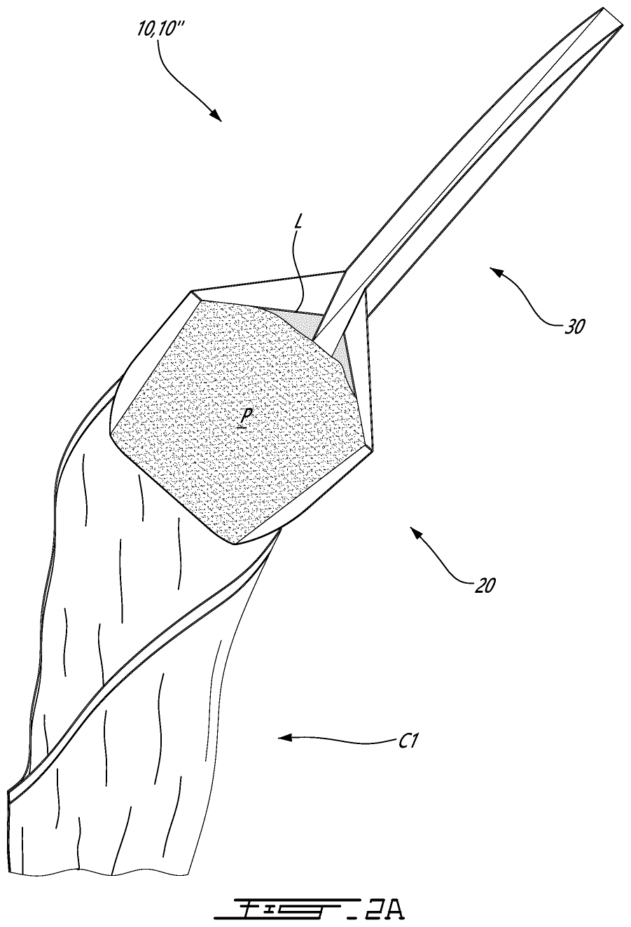

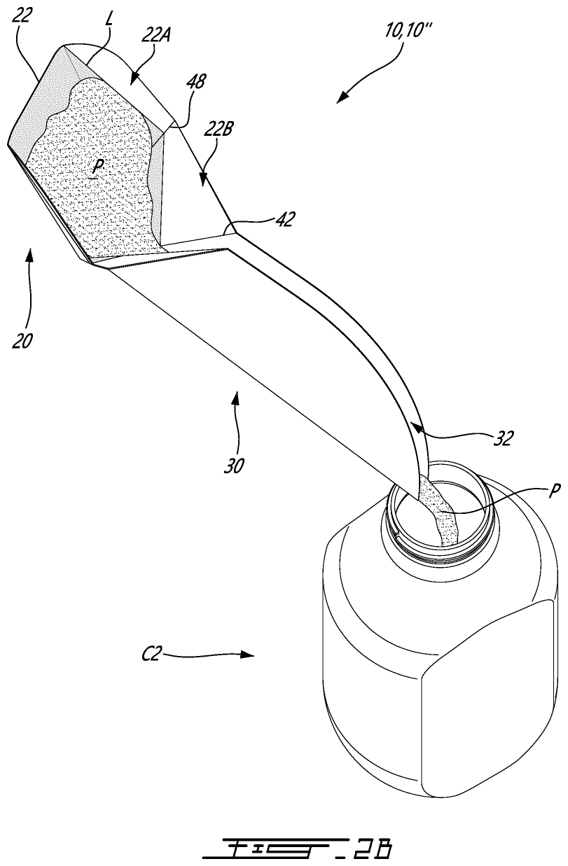

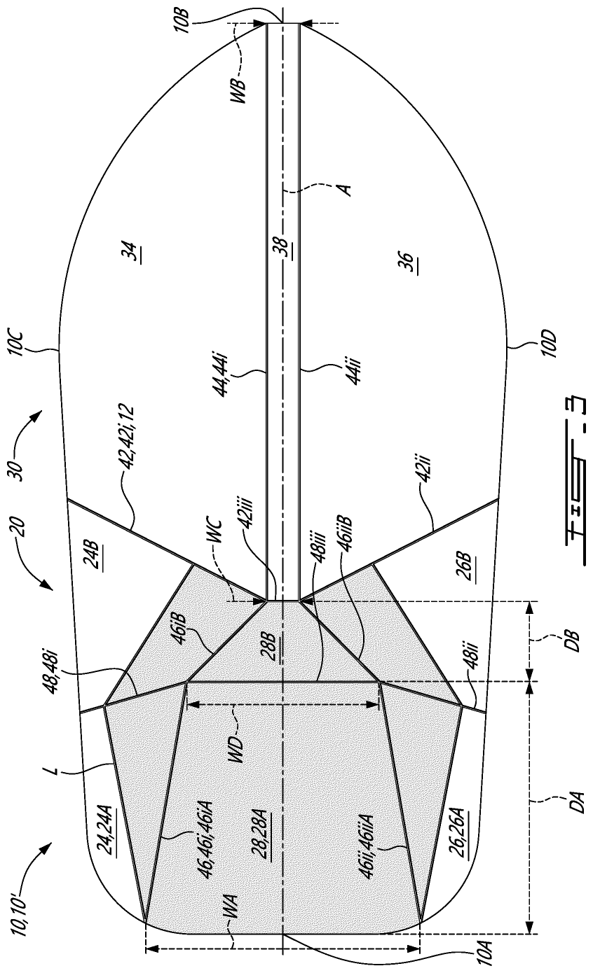

With reference to the Figures, there is shown at 10 a scoop comprising a sheet of foldable material, preferably of compostable or recyclable material such as cardboard. The scoop is structured and arranged to be reversibly configurable between a flat, non-folded configuration 10′ (blank-FIG. 3) and a formed, folded configuration 10″ (FIGS. 1-2B). In the formed configuration 10″, the scoop 10 exibits three-dimensional geometrical features adapting the scoop 10 to perform the function of scooping a portion of material in powdery/granular form in an efficient manner. With such functionality, the scoop 10 may assist a user in collecting, portioning and/or dispensing a product P (see FIGS. 2A-2B) that is provided in granulated and/or powdered form, such as beverage powder provided in a bag C1. In one embodiment, the blank of the spoon 10 can be included in the bag, together with the beverage powder, at the point of sale.

Referring to FIG. 1, the scoop 10 extends longitudinally along an axis A from a front side 10A to a rear side 10B. In the formed configuration 10″, the scoop 10 defines a cup portion 20 (hereinafter “the cup 20”) extending from the front side 10A and a handle portion 30 (hereinafter “the handle 30”) extending from the rear side 10B. The cup 20 and the handle 30 are arranged relative to one another so as to define a scoop-like structure. More specifically, pre-formed fold lines referred to herein as “scores” can be formed in the blank to delimit ends of the handle 30 from rear portions of the cup 20 and operable to generally fold the cup portion into a 3D cup shape, including raising the rear and lateral portions relative to a cup area, upon folding of the two handle halves towards one another.

In one example embodiment, the cup 20 defines a cavity 22 and the handle 30 has a central intermediary portion located between the two handle halves which remain unfolded and defines a channel 32 when the two handle halves are folded towards one another. The channel 32 can be aligned with and in register with the cavity 22 of the cup 20, in a manner that the channel 32 is in powder flow communication with powder contained in the cup 20, such that, when the loaded scoop 10 is inclined with the handle downward and the cup 20 upward, powder can be guided by a funnel-like structure to flow from the cavity into and along the channel and into a small area such as a bottle opening shown in FIG. 2B. In this manner, the scoop 10 can also act as a funnel.

In the embodiment presented in FIG. 1, a junction 12 between the cup 20 and the handle 30 may be said to form an opening via which the cavity 22 of the cup 20 and the channel 32 of the handle 30 communicate. The cavity 22 is open toward the front side 10A, whereas the channel 32 is open toward the rear side 10B. The scoop 10 may thus be used in its formed configuration 10″ to collect a desired amount of the product P into the cavity 22 of the cup 20 from the front side 10A. Then, optionally, the collected product P may be transferred from the cavity 22 and into the channel 32 via the funnel-like structure. Ultimately, the collected product P may be dispensed from the scoop 10 via the channel 32 from the rear side 10B. The scoop 10 may be provided with a number of different internal widths defined transversely relative to the axis A and which are suitable for handling the product P as evoked above. For example, the cavity 22 defines a front interior width WA of the scoop 10 at the front side 10A, whereas the channel 32 defines a rear interior width WB of the scoop 10 at the rear side 10B that may be smaller than the front interior width WA. By this arrangement, the scoop 10 may be used to dispense the product P into a container for example having an opening that is smaller than the front interior width WA, while being easy to load via the front interior width WA.

At the junction 12, the scoop 10 is provided with a junction interior width WC that is smaller than the front interior width WA. The junction interior width WC may in some embodiments correspond to the rear interior width 10B, and be relatively small. By this arrangement, the scoop 10 may be used to substantially confine the collected product P in the cavity 22 of the cup 20 as it is collected from the front side 10A, allowing the product P to accumulate in the cavity 22 while limiting entry of product P into the channel 32 while the scoop 10 is held generally horizontally. In the illustrated embodiment, an additional intermediary interior width WD is formed at the beginning of the funnel-like structure, the latter partially delimiting the cavity.

An embodiment, the cavity 22 may configured and marked in a manner to define a portion size when folded, and the portion size can be relatively precise when folded, allowing a greater regularity of product volume delivery from one use to a next. The overall internal cavity volume can be greater than the serving volume (i.e., a product-specific volume corresponding to a single serving thereof). Hence, the scoop 10 may be used to portion the product P via the cup 20 with a suitable degree of accuracy, by filling the cavity with product to a level matching the marking corresponding to a predetermined volume of product. The marking can be in the form of a level indicator L provided on an internal face of the scoop 10 when folded and being indicative of a level up to which the product P is to reach in the cavity 22 in order for the volume of collected product P to correspond to the desired serving volume.

In one embodiment, the level indicator L is in the form of a delimitation between a portion area and an excess area, and the portion area and the excess area can be of different colors or different shades for instance. In another embodiment, the level indicator L can simply be provided in the form of a line. Various types of level indicators L may be used in alternate embodiments, including marks (e.g., symbols, patterns), embossings, and the like. In the depicted embodiment, the level indicator L is a portion of the interior surface of the cup 20 that contrasts with a remainder thereof. Suitable contrast may be provided for example by different textures, colors, and/or even different shades of a same color. Such a contrasting surface being barely covered by product P indicates to the user that the cup 20 contains the desired serving volume, such as shown in FIG. 2A.

To assist in the step of transferring the product P from the cavity 22 to the channel 32, at least part of the cavity 22 may have a funnel-like structure which funnels away from the front side 10A and toward the channel 32. In some embodiments, the cavity 22 is formed of a scoop 22A (or front cavity portion) located at the front side 10A and being wider than the channel 32, and a funnel 22B (or rear cavity portion) located between the scoop 22A and the channel 32, and which narrows relative to the axis A as it extends from the scoop 22A to the channel 32. Hence, the cavity 22 may define a front funnel width WD where the fore portion of the cavity 22A meets the funnel 22B. The front funnel width WD may in some embodiments be comparable to the front side width WA. In the depicted embodiment, the scoop 22A narrows relative to the axis A as it extends toward the funnel 22B, and the front funnel width WD is slightly smaller than the front interior width WA, albeit less so than through the funnel 22B.

Contemplated usage of the scoop 10 is schematically illustrated in FIGS. 2A and 2B. First, in FIG. 2A, the scoop 10 is shown inclined with the cup 20 being disposed lower than the handle 30, so that the cup 20 may be plunged into container C1 (e.g. a supple bag of powdery material in this example) to collect the powdery product P while the scoop 10 is held via the handle 30. This may be referred to as a collecting mode of the scoop 10. Generally, during the collecting mode, the cup 20 is inclined lower than the handle 30. The scoop 10 may then be oriented generally horizontally so that the collected product P may settle in the cavity 22, after which the collected volume may be checked against the level indicator L, in an optional measuring mode of the scoop 10.

In FIG. 2B, the scoop 10 is shown inclined with the handle 30 being disposed lower than the cup 20, so that the handle 30 may rest against an opening of container C2. This may be referred to as a dispensing mode of the scoop 10. In this mode, the product P may gravitationally transit from the cavity 22 of the cup 20 to the container C2 via the channel 32 of the handle 30. Of course, the product P can alternately be delivered directly from the cup 20, but some bottles for instance, can have openings which are smaller than the cup (e.g. bottle opening having a diameter smaller than the front interior width WA), in which case using the spoon as a funnel and delivering the product P from the handle can be perceived as more practical.

Turning now to FIG. 3, features of the scoop 10 intended to assist the user in configuring the scoop 10 from the flat configuration 10′ to the formed configuration 10″ will now be described. For instance, the sheet of the scoop 10 may be provided with a pattern of linear guiding elements along which the scoop 10 may be deformed via folding. The linear guiding elements may be of one or more suitable types, including scores, embossings, perforations and/or printouts or other features guiding the folding action along a specific path and referred to generally as scores 40 herein for convenience. Hence, when the scoop 10 is in the flat configuration 10′, the scores may be recessed relative to a thickness of the scoop 10, may protrude relative to the thickness, or may be flush with the thickness, depending on their type.

The scores 40 include a lateral score 42 extending across the sheet from the first side 10C to the second side 10D. The lateral score 42 may be said to delimit the cup 20 from the handle 30. As such, the cup 20 extends from the front side 10A to the lateral score 42, and the handle 30 extends from the lateral score 42 to the rear side 10B. It should be noted that in the formed configuration 10″, the lateral score 42 defines the opening 12. In the present embodiment, the lateral score 42 includes a first lateral score segment 42i extending away from the axis A toward the first lateral side 10C, and a second lateral score segment 42ii extending away from the axis A toward the second lateral side 10D. In some embodiments, the first and second lateral score segments 42i, 42ii respectively extend away from the axis at an acute angle toward the rear side 10B. In some embodiments, the first and second lateral score segments 42i, 42ii are spaced away from one another, and the lateral score 42 includes a third lateral score segment 42iii extending therebetween. A length of the third lateral score segment 42iii may correspond to the junction interior width WC.

The scores 42 also include at least one longitudinal score 44 extending in the handle 30 along the axis A, i.e., at least one longitudinal handle score 44. In embodiments, the handle 30 includes a pair of longitudinal handle scores 44i, 44ii that are spaced apart, dividing the handle 30 in three handle panels 34, 36, 38. A first handle panel 34 extends from the first side 10C to a first one of the longitudinal handle scores 44i, 44ii. A second handle panel 36 extends from the second side 10D to a second one 44ii of the longitudinal handle scores 44i, 44ii. A third handle panel 38 extends between the longitudinal handle scores 44i, 44ii. The first and second handle panels 34, 36 may be said to form sides of the channel 32, whereas the third handle panel 38 may be said to form a bottom of the channel 32. The channel 32 having a bottom provided by the third handle panel 38 (instead of having converging first and second handle panels 34, 36 as the case may be present when a sole longitudinal handle score 44 is provided) may desirably promote a continuous, regular flow of the product P. More specifically, the folds between the panels 34 and 38, and 36 and 38 can remain roughly at 90 degrees when pouring, and folds at 90 degrees or greater may be preferred to folds significantly smaller than 90 degrees as the latter may tend to impede the flow of the powdery product P. In the depicted embodiment, the longitudinal handle scores 44i, 44ii are parallel, and are spaced apart by a distance corresponding to the junction interior width WC. Accordingly, in such embodiments, the rear interior width WB corresponds to the junction interior width WC. In other embodiments, the first and second handle panels 34, 36 may otherwise extend at a slight angle relative to the axis A, such that the rear interior width WB and the junction interior width WC differ.

In some embodiments, the scores 40 include a pair of longitudinal scores 46 defined in the cup 20, i.e., a first longitudinal cup score 46i and a second longitudinal cup score 46ii that extend from the front side 10A toward the lateral score 42. In some embodiments, the first and second longitudinal cup scores 46i, 46ii meet at a location spaced away from the front side 10A and thus define sides of a triangle, whereas the front side 10A defines a base of the triangle. In other embodiments, the first and second longitudinal cup scores 46i, 46ii are instead spaced from one another. In the depicted embodiment, the first and second longitudinal cup scores 46i, 46ii are slightly angled relative to the axis A and thus define sides of a trapezoid, whereas the front side 10A defines a base of the trapezoid. The longitudinal scores 46 divide the cup 20 in three cup panels 24, 26, 28. A first cup panel 24 extends from the first side 10C to the first longitudinal cup score 46i. A second cup panel 26 extends from the second side 10D to the second longitudinal cup score 46ii. A third cup panel 28 extends between the longitudinal cup scores 46i, 46ii. The first and second cup panels 24, 26 may be said to form sides of the cavity 22, whereas the third cup panel 28 may be said to form a bottom of the cavity 22.

Still referring to FIG. 3, in some embodiments, the scores 40 include another lateral score 48 that extends across the sheet from the first side 10C to the second side 10D in the cup 20, at suitable distances from the first side 10A and from the lateral score 42. The cup 20 may thus be said to include a lateral cup score 48 which delimits the scoop 22A from the funnel 22B. In the present embodiment, the lateral cup score 48 includes a first lateral cup score segment 48i extending away from the axis A toward the first lateral side 10C, and a second lateral cup score segment 48ii extending away from the axis A toward the second lateral side 10D. In some embodiments, the first and second lateral cup score segments 48i, 48ii respectively extend away from the axis A at a slight acute angle toward the front side 10A. In some embodiments, the first and second lateral cup score segments 48i, 48ii are spaced away from one another, and the lateral cup score 48 includes a third lateral cup score segment 48iii extending therebetween. A length of the third lateral cup score segment 48iii may correspond to the front interior width WA. A longitudinal dimension DA of the scoop 22A may be greater than a longitudinal dimension DB of the funnel 22B.

In some embodiments, the lateral cup score 48 divides the first, second and third cup panels 24, 26, 28 respectively in front and rear first cup panels 24A, 24B, front and rear second cup panels 26A, 26B, and front and rear third cup panels 28A, 28B. Likewise, the lateral cup score 48 divides the first and second longitudinal cup scores 46i, 46ii respectively in a front and a rear first longitudinal cup score segment 46iA, 46iB, and in a front and a rear second longitudinal cup score segment 46iiA, 46iiB. In this embodiment, the front longitudinal cup score segments 46iA, 46iiA are angled significantly less relative the axis A than the rear longitudinal cup score segments 46iB, 46iiB. The latter rear longitudinal cup score segments 46iB, 46iiB are closer in shape to a triangle than to a trapezoid, with the exception of the minor width WC, which makes them better adapted to the function of funneling product from the front cup portion to the conduit formed by the panels 34, 38, 36 of the handle portion.

It should be noted that in the present embodiment, the level indicator L spans across the entirety of the front and rear third cup panels 28A, 28B, whereas it extends across inner portions of the front and rear first cup panels 24A, 24B and of the front and rear second cup panels 26A, 26B, stopping short of the first and second sides 10C, 10D. In an alternate embodiment, the level indicator L may be omitted from the front and rear third cup panels 28A, 28B.

When the scoop 10 is in the formed configuration 10″, the first rear cup panel 24B, the second rear cup panel 26B and the third rear cup panel 28B define the funnel 22B. The length of the third lateral cup score segment 48iii corresponds to the funnel width WD. As perhaps best seen in FIG. 1, the funnel 22B may be taller than the scoop 22A in some embodiments. Optionally, the funnel 22B may be taller proximate to the channel 32 than it is tall proximate to the scoop 22A. Such arrangements of the funnel 22B may assist in preventing the product P from overspilling from the cup 20 when the scoop 10 is used in the dispensing mode. One or more of the following features may be suitable to impart such functionality to the funnel 22B. The front longitudinal cup score segments 46iA, 46iiA may converge toward the axis A as they extend toward the third lateral cup score segment 48iii, defining a front acute angle relative to the axis A toward the front side 10A. The rear longitudinal cup score segments 46iB, 46iiB may converge toward the axis A as they extend away from the third lateral cup segment 48iii, defining a rear acute angle relative to the axis A toward the front side 10A. The rear acute angle may be greater than the front acute angle. A length of the first and second lateral score segments 42i, 42ii may be greater than a length of the first and second lateral cup score segments 48i, 48ii. The first and second sides 10C, 10D may diverge relative to the axis A as they extend away from the first and second lateral cup score segments 48i, 48ii toward the first and second lateral score segments 42i, 42ii.

As can be understood, the examples described above and illustrated are intended to be exemplary only. Indeed, in an alternate embodiment, the handle halves may be directly connected to one another by a fold line, rather than by an intermediary panel. In an alternate embodiment, the only fold lines provided may be rearwardly oblique lines 42i and 42ii, and one or two folds between the handle halves. However, providing at least two oblique folds such as 46i and 46ii, which may lead directly and straight to an intersection point with folds 42i and 42ii, may help in providing a flat bottom and flat sides to the cup, which may help in achieving regularity of the internal volume configuration over subsequent uses. In the embodiment presented, intermediary folds 46iB, 46iiB are provided between the folds 46i and 46ii and the intersection point with folds 42i and 42ii, transverse folds 48iii and 42iii are provided, and forwardly oblique folds 48i and 48iii are also provided, collectively contributing to sharply defining an intermediary funneling area of the scoop. In the embodiment presented, the lateral panels 24B and 26B are relatively thick, providing height to sustain some volume of the powder material when performing the funneling operation, and lateral walls 24A and 26A are further provided, but in alternate embodiment, these features can have other shapes. In the illustrated embodiment, the handle is broader than the cup portion when the scoop is unfolded, and the lateral edges extend straight and continuously between the handle portion and the cup portion. The latter feature can be advantageous in some embodiments and can be omitted in some alternate embodiments. The scope is indicated by the appended claims.

1. A scoop comprising:
a sheet constructed of a foldable material, the sheet extending longitudinally along an axis between a front side and a rear side and laterally between a first lateral side and a second lateral side on either side of the axis, the sheet including:
a lateral score extending across the sheet including a first lateral score segment and a second lateral score segment extending away from the axis and respectively toward the first lateral side and the second lateral side;
a handle portion extending from the rear side to the lateral score, the handle portion including at least one longitudinal handle score extending between the lateral score and the rear side; and
a cup portion extending from the front side to the lateral score, the cup portion including a lateral cup score extending across the sheet from the first lateral side to the second lateral side;
wherein the sheet is reversibly configurable between:
a flat configuration in which the cup portion and the handle portion lay flat; and
a formed configuration in which the cup portion defines a cavity and the handle portion defines a channel in register with the cavity, the cavity defining a funnel narrowing from the lateral cup score to the lateral score.

2. The scoop of claim 1, wherein when the sheet is in the formed configuration, the cavity defines a scoop extending from the front side to the lateral cup score, the scoop having a longitudinal dimension greater than that of the funnel.

3. The scoop of claim 1 wherein the cup portion further includes a pair of longitudinal cup scores extending between the front side and the pair of lateral score, towards the axis, and lateral sheet edges extending continuously along the first lateral side and the second lateral side, alongside both the handle portion and the cup portion.

4. The scoop of claim 3 wherein the cup portion includes a central cup portion laterally between the lateral sheet edges, the central cup portion having a first portion extending longitudinally between the lateral cup score and the lateral score, and a second portion extending longitudinally between the lateral cup score and the front side, both the first portion and the second portion being trapezoidal in shape.

5. The scoop of claim 4 wherein the first portion is closer in shape to a triangle than the second portion.

6. The scoop of claim 1 wherein the handle portion has at least two of said at least one longitudinal handle score, the at least two longitudinal handle scores extending parallel from one another and defining a delivery channel bottom when in the formed configuration.

7. The scoop of claim 6 wherein the at least two longitudinal handle scores includes two longitudinal handle scores.

8. A scoop comprising:
a sheet constructed of a foldable material, the sheet extending longitudinally along an axis between a front side and a rear side and laterally between a first lateral side and a second lateral side on either side of the axis, the sheet including:
a lateral score extending across the sheet including a first lateral score segment and a second lateral score segment extending away from the axis and respectively toward the first lateral side and the second lateral side;
a handle portion extending from the rear side to the lateral score, the handle portion including a pair of longitudinal handle scores spaced apart and extending between the lateral score and the rear side; and
a cup portion extending from the front side to the lateral score;
wherein the sheet is reversibly configurable between:
a flat configuration in which the cup portion and the handle portion lay flat; and
a formed configuration in which the cup portion defines a cavity and the handle portion defines a channel in register with the cavity.

9. A scoop comprising:
a sheet constructed of a foldable material, the sheet extending longitudinally along an axis between a front side and a rear side and laterally between a first lateral side and a second lateral side on either side of the axis, the sheet including:
a pair of lateral scores extending across the sheet including a first lateral score segment and a second lateral score segment extending away from the axis and respectively toward the first lateral side and the second lateral side, the first and second lateral scores extending transversally to the axis, obliquely relative the axis and towards the rear;
a handle portion extending from the rear side to the pair of lateral scores, the handle portion foldable in half around the axis; and
a cup portion extending from the front side to the lateral score, the cup portion including a pair of longitudinal cup scores extending between the front side and the pair of lateral score, towards the axis;
lateral sheet edges extending continuously along the first lateral side and the second lateral side, alongside both the handle portion and the cup portion;
wherein the sheet is reversibly configurable between:
a flat configuration in which the cup portion and the handle portion lay flat in a common plane; and
a formed configuration in which the cup portion defines a cavity and the handle portion defines a channel in register with the cavity.

10. The scoop of claim 9, wherein the cup portion includes a level indicator extending from the front side to the lateral score.

11. The scoop of claim 10 wherein the level indicator includes a marking extending longitudinally along the lateral sheet edges, within the cup portion.

12. The scoop of claim 9 further comprising a pair of lateral cup scores extending transversally from the axis and obliquely towards the front, the pair of lateral cup scores being longitudinally between the front and the pair of lateral scores.

13. The scoop of claim 9, wherein the handle portion has a pair of longitudinal handle scores parallel to one another and to the axis and delimiting a central panel between two halves.

14. The scoop of claim 9, wherein the first lateral score segment and the second lateral score segment respectively extend away from the axis at an acute angle toward the rear side.

15. The scoop of claim 9, wherein the lateral score includes a third lateral score segment extending from the first lateral score segment to the second lateral score segment.

16. The scoop of claim 15, wherein the longitudinal handle scores extend from the third lateral score segment.

17. The scoop of claim 9, wherein each one of the longitudinal cup scores includes a front longitudinal cup score segment extending from the front side to the lateral cup score, and a rear longitudinal cup score segment extending from the lateral cup score to the lateral sheet score.

18. The scoop of claim 17, wherein the front longitudinal cup score segment and the rear longitudinal cup score segment of each one of the longitudinal cup scores extend at an angle relative to one another.

19. The scoop of claim 17, wherein the rear longitudinal cup score segment of each one of the longitudinal cup scores extends to a corresponding one of the pair of longitudinal handle scores.

20. The scoop of claim 17, wherein the lateral cup score includes a first lateral cup score segment extending from the first side, a second lateral cup score segment extending from the second side, and a third lateral cup score segment extending between the first lateral cup score and the second lateral cup score.
